(19) United States
(12) Patent Application Publication
(10) Pub. No.: US 2024/0207026 A1
(43) Pub. Date: Jun. 27, 2024

(54) METHOD FOR PRODUCING A DENTAL PROSTHESIS BY FILLING AN INTERSPACE

(71) Applicant: Kulzer GmbH, Hanau (DE)

(72) Inventors: Frank-Uwe Stange, Langenargen (DE); Matthias Moeller, Eriskirch (DE); Karl-Heinz Renz, Elsenfeld (DE)

(21) Appl. No.: 18/545,267

(22) Filed: Dec. 19, 2023

(30) Foreign Application Priority Data
Dec. 22, 2022 (DE) 10 2022 134561.0

(51) Int. Cl. A61C 13/36; A61C 13/00; A61C 13/103

(52) U.S. Cl. CPC A61C 13/1016; A61C 13/0004; A61C 13/1009

(57) ABSTRACT

The invention relates to a method for producing a dental prosthesis with:
A) provision of a milling body and a prosthesis base preform with a holding structure (34);
B) production of a connecting surface in the milling body by a subtractive CAM method;
C) production of mating holding structure which fits with the holding structure in the surface of the milling body or said mating holding structure is present;
D) attachment, spaced via the holding structure, of the prosthesis base preform to the mating holding structure, wherein an interspace is obtained;
E) introduction or application of a fluid polymerizable plastic into the interspace;
F) curing or partial curing of the plastic to yield a plastics material in the interspace which connects the prosthesis base preform to the milling body; and
G) subtractive machining of the plastics material, the prosthesis base preform and the milling body by a CAM method in accordance with a model of the dental prosthesis.

The invention also relates to a dental prosthesis produced with such a method and a device for implementing such a method.

The invention relates to a method for producing a dental prosthesis, such as a partial or full dental prosthesis, as well as to a dental prosthesis produced using such a method and to a device for implementing the method.

In addition to craft skills, digital manufacturing methods are becoming increasingly significant in the dental sector. Dentures and other dental moldings, such as for example dental prostheses, crowns, bridges and occlusal splints have for some years been produced by subtractive milling methods using computer-aided design/computer-aided manufacturing (CAD/CAM) technologies. CAD/CAM methods are increasingly also used in the production and design of partial and full dental prostheses with a prosthesis base for lying against the gingiva and prosthetic teeth attached or arranged therein.

For the purposes of digital design of prosthetic work, in particular of partial or total prostheses, the structure is divided into a “white” or tooth-colored tooth portion (the prosthetic teeth) and a gum-colored (“pink”) prosthesis base portion (the prosthesis base). Dental prostheses consequently consist of a gum- or pink-colored base and tooth-colored portions (prosthetic teeth or tooth segments).

There are methods, such as for example the methods known from DE 10 2009 056 752 A1 or WO 2013/124 452 A1, in which a partial or full dental prosthesis is waxed up digitally and produced by means of CAD/CAM methods. Patent DE 103 04 757 B4 discloses a method for producing dental prostheses in which the teeth are virtually waxed-up in a virtual model and a prosthesis base is produced on the basis of the virtual model. EP 2 742 906 A1 discloses a method in which a dental arch is connected to an impression composition, wherein the impression composition is held in an individualized impression tray and contains an impression of the situation in the patient's oral cavity. The surface of the mold with the dental arch is digitized and then a virtual model of the dental arch is computationally positioned and oriented with the best possible fit in the virtual model of the prosthesis base.

For the purposes of digital total prosthetics or partial prosthetics, prosthetic teeth or dental moldings are required which can be clearly and reproducibly adhesively bonded to the prosthesis base.

WO 2016/091 762 A1 discloses a method for producing a dental prosthesis, in which a jig is produced with which a plurality of prosthetic teeth may be fastened in the desired location and orientation relative to one another on a prosthesis base. In this case, the prosthetic teeth are shortened by basal grinding in a cervical region, to achieve the desired occlusal height. WO 2016/110 392 A1 discloses a method for producing a dental prosthesis, in which a plastically deformable connecting means is introduced into dental alveoli of a prosthesis base in order to enable manual correction of the orientation of the prosthetic teeth in the prosthesis base. DE 10 2008 019 694 B3 discloses a method and apparatus for producing dental moldings from ceramics with a laser. EP 2 571 451 B1 and EP 2 666 438 A2 disclose methods for producing dental prostheses in which prefabricated prosthetic teeth are embedded in a wax mount and then milled away cervically by means of CAM methods. It is necessary to shorten the prosthetic teeth basally (or cervically) in order to adapt tooth height to the patient's jaw, i.e. to tailor the occlusal height of the dental prosthesis to the patient's requirements. WO 2014/159 436 A1 discloses a layered dental prosthesis having, in the prosthesis base, a reinforcement which is cast into a basal cavity. In addition to dental prostheses, other dental moldings such as occlusal splints can also be produced digitally on the basis of patient data by subtractive CAM methods. One drawback of such occlusal splints is that they must have sufficient abrasion resistance but this reduces wearer comfort relative to the teeth. In addition, there are limited options for aesthetically modifying occlusal splints.

In both additive and subtractive production, connecting the base and tooth-colored portions (prosthetic teeth) is a major challenge. Connection is generally achieved by adhesive bonding, wherein the quality of the transitions is problematic due to the use of too little or too much adhesive as well as correct positioning of the prosthetic teeth during adhesive bonding. While one-part, two-colored (gum-colored and tooth-colored) milling blanks, which are also available, do have a very good connection between the layers, the aesthetics are always a compromise and so unsatisfactory due to the predetermined phase boundaries.

DE 10 2017 117 4912 A1 discloses a method for producing a dental prosthesis in which a prosthesis base is milled in two steps and the prosthetic teeth are then fastened to the prosthesis base. US 2022/0110730 A1 discloses a two-part denture, in which a dental arch portion and a gum portion are fastened to one another by way of structures which fit together. US 2022/0096217 A1 discloses an array device and an array method in which artificial teeth are to be attached to a denture plate, wherein arrangement of the artificial teeth is simplified with a body having recesses in conformity with the artificial teeth and with positioning portions.

US 2013/0101962 A1 discloses a method for producing a dental prosthesis, wherein in the method a plurality of indentations along a dental arch are milled in a block, wherein a plurality of plastics are introduced into the indentations, after which the prosthetic teeth are fabricated from the plastics which have cured in the indentations. The block is then largely machined away and the prosthesis base fabricated from the block. The method is a multistage milling method. Drawbacks of the method according to US 2013/0101962 A1 are the major loss of material, the time taken for machining away the material of the block and the wear to the tools required for this purpose. EP 2 915 503 B1 discloses a reverse method for producing a dental prosthesis in which a milling blank of a dental enamel material is subtractively machined in order to produce a cavity which is used as the negative mold for a prosthesis base of a dental prosthesis. The occlusal side and basal side of the dental prosthesis are then produced subtractively from the resultant composite. This too is a multistage milling method. A drawback of the method according to EP 2 915 503 B1 is that very large quantities of the relatively hard dental enamel material and of the other materials have to be removed in order to fabricate the dental prostheses. Not only is a large quantity of the dental enamel material and the other materials lost but the milling tools are subjected to severe stress and the time requirement for implementing the method is relatively long.

Some of the introduced gum-colored material also has to be removed after it has cured in the rear cavity of the dental enamel material. This still further increases material consumption and thus the time taken for implementation as well as tool stress.

If a multistage process is selected in which the prosthetic teeth and/or the prosthesis base are to be fabricated from a plurality of different materials, material consumption and thus the time requirement and tool stress are further amplified.

Furthermore, if the dental enamel material is incompletely removed from the outer sides (the occlusal and oral side) of the prosthesis base, aesthetically troublesome white or tooth-colored residues then remain which have to be removed manually by a dental technician. This may in turn lead to unwanted thinning of the material thickness of the prosthesis base.

A further drawback of such methods is that either the prosthetic teeth or the prosthesis base have to be fabricated from castable plastics such as PMMA-based materials. This limits material selection.

The following options are available in the prior art for the production of digitally designed total prostheses:
1. Milling or printing the gum-colored base and adhesive bonding with artificial teeth, alternatively with milled or printed tooth-colored segments. Drawbacks may include: fabrication inaccuracy, time requirement, aesthetic challenges due to adhesive excesses or underfilling of marginal gaps, limitations regarding millability of cavities because of undercuts.
2. Milling of prefabricated milling disks with integral biphasic structure. This involves an attempt to achieve natural aesthetics by skillful arrangement of the transitions. The drawback is the position of the gum-colored to tooth-colored transitions which are always a compromise and aesthetically unsatisfactory.
3. Milling of preformed moldings in which the prefabricated teeth are already integrated. In these methods, it is mainly only the basal side of the prosthesis which is still individually made. The drawback is that compatibility with individual patient cases is extremely limited and numerous variants of preformed moldings have to be held in stock.
4. Layer-by-layer construction of a prosthesis consisting of tooth-colored individual layers and a prosthesis base by repeated milling and refilling of the milled cavities. Drawbacks are the major loss of material and the time requirement.

The object of the invention is to overcome the disadvantages of the prior art. In particular, the intention is to identify a possible way of providing a method for producing a dental prosthesis, a dental prosthesis, and a device for producing a dental prosthesis from at least two different materials which are firmly connected together, with which dental moldings can be rapidly and resource-efficiently manufactured by way of subtractive CAM methods and optionally also additive CAM methods. In the method, the intention is to ensure that the least possible material need be removed both from the material for the prosthetic teeth and from the material for the prosthesis base. In particular, it should be possible for the at least two materials to be joined together in the course of the method. Material selection should be as free as possible. In particular, the intention is to avoid the prosthetic teeth and the prosthesis base completely consisting of a cured and previously liquid plastic. The method needs to be as easy and straightforward as possible for a dental technician to implement. In particular, fully automated or maximally automated methods such as CAD/CAM technologies should be used and usable.

The objects of the invention are achieved by a method according to Claim 1, a dental prosthesis according to Claim 27 and a device for implementing the method according to Claim 29. Preferred variants are claimed in Subclaims 2 through 26, 28 and 30.

The objects of the invention are thus achieved by a method for producing a dental prosthesis, wherein the dental prosthesis has a plurality of prosthetic teeth and a prosthesis base, wherein the prosthesis base includes a gum-colored plastic and wherein the prosthetic teeth and the prosthesis base are firmly connected together in the method, wherein the method is characterized by the following steps:
A) Providing a milling body for producing the prosthetic teeth from a material suitable for prosthetic teeth and providing a prosthesis base preform, wherein the prosthesis base preform has a holding structure on an oral side of the prosthesis base preform;
B) Producing a connecting surface between the prosthetic teeth and the prosthesis base in a surface of the milling body with the assistance of a subtractive CAM method in accordance with a virtual three-dimensional model of the connecting surface of the prosthetic teeth to the prosthesis base in the dental prosthesis;
C) Producing a mating holding structure in the surface of the milling body, wherein the mating holding structure forms a counterpart which fits with the holding structure of the prosthesis base preform, or the milling body has the mating holding structure which fits with the holding structure of the prosthesis base preform;
D) after steps A), B), and C), Attaching the prosthesis base preform with the holding structure to the mating holding structure of the milling body, wherein, apart from at the mating holding structure, the prosthesis base preform is attached spaced apart from the machined surface of the milling body such that an interspace open to the outside is obtained between the prosthesis base preform and the milling body;
E1) after step D), Introducing at least one fluid polymerizable plastic or adhesive into the interspace between the milling body and the prosthesis base preform and into the volume in the surface of the milling body machined away in step B); and/or
E2) before step D), Applicating at least one fluid polymerizable plastic or adhesive onto an oral surface of the prosthesis base preform and/or onto the connecting surface produced in step B) of the milling body;
F) after step E1) or after step E2) or after step D), Curing or partial curing of the at least one fluid polymerizable plastic or adhesive, wherein, on curing, a cured plastics material is obtained in the interspace or, on partial curing, a partially polymerized plastics material is obtained in the interspace, wherein the cured plastics material or the partially polymerized plastics material connects the prosthesis base preform firmly and flush to the material of the milling body; and
G) after step F), subtractive machining of the cured or partially polymerized plastics material, the prosthesis base preform and the milling body by a CAM method in accordance with a virtual model of an outer surface of the dental prosthesis, such that the dental prosthesis is subtractively carved out from the prosthesis base preform, the cured or partially polymerized plastics material and the material of the milling body.

Steps A), B), C), D), F) and G) are necessarily performed in an inventive method, while either step E1) or step E2) or steps E1) and E2) have to be performed in the inventive method. Provision may preferably be made for either step E1) or step E2) but not both to be carried out.

The material suitable for the prosthetic teeth is preferably a finally cured tooth-colored plastic, but may also be a suitable tooth-colored ceramic. Such materials for producing prosthetic teeth are known to a person skilled in the art.

The material for the prosthetic teeth (i.e. the material of the milling body or at least the part of the milling body from which the prosthetic teeth are fabricated), the at least one fluid polymerizable plastic or adhesive, the gum-colored plastic and all the other materials from which the prosthesis base preform is fabricated must be biocompatible and be suitable and approved for use in a patient's oral cavity.

Provision may be made for the material for the prosthetic teeth to be a plastic or a plastics composition, preferably a polymethyl methacrylate (PMMA) or a PMMA-containing plastics composition and/or a heat-curing polymer.

For the purposes of the present invention, a milling body is a solid which is suitable for subtractive machining with milling tools and the geometric dimensions of which are suitable for handling in CAM milling machines.

Provision may be made for the prosthesis base preform to have no connecting faces which are intended to be placed against the prosthetic teeth. This ensures that the prosthetic teeth are connected to the prosthesis base preform via the at least one fluid polymerizable plastic or adhesive and a sufficient interspace or sufficient gap is provided for this purpose.

Provision may also be made for the interspace to have or provide a uniform gap dimension between the oral surface of the prosthesis preform and the surface of the milling body machined in step B). To this end, the prosthesis base preform may accordingly be formed on the oral side, preferably produced by way of an additive CAM method, particularly preferably printed with a 3D printer, in accordance with the virtual three-dimensional model of the shape of the connecting surface of the prosthetic teeth to the prosthesis base in the dental prosthesis with an offset as spacing.

The oral side and oral surface of the prosthesis preform or dental prosthesis should here be taken to mean the surface/side pointing toward the oral cavity, i.e. the surface/side pointing away from the bearing face on the gums.

The attachment of the prosthesis base preform to the machined milling body in step D) may be carried out location-independently and flexibly. Time may be saved as a result.

Provision may be made for the attachment of the prosthesis base preform to the machined milling body in step D) to be carried out in a CAM device for implementing the CAM method in steps B) and G), wherein the milling body preferably remains fixed in the CAM device for implementing the CAM method in steps B) to G). It is not necessary to remove the machined milling body in order to attach the prosthesis base preform. According to the invention, the CAM device may preferably be a milling machine, particularly preferably a computer-controlled multiaxial milling machine.

An interspace open to the outside interspace should be taken to mean an interspace which is open in the direction of the surroundings of the system consisting of the machined milling body and prosthesis base preform attached thereto, such that the interspace is accessible from outside. In this way, the at least one fluid polymerizable plastic or adhesive may for example be introduced from outside into the interspace.

If the at least one fluid polymerizable plastic or adhesive has already previously been applied in a step E2), the interspace may be partially or completely filled with the at least one fluid polymerizable plastic or adhesive applied in step E2), after the prosthesis base preform was attached to the machined milling body in step D).

The prosthesis base preform preferably consists of the gum-colored plastic or is produced from the gum-colored plastic. Provision may alternatively be made for a reinforcement, in particular a metallic reinforcement, to be embedded in the gum-colored plastic.

The subtractive machining in step G) preferably proceeds such that the dental prosthesis is subtractively carved out from the prosthesis base preform, the cured or partially polymerized plastics material and the material of the milling body such that the outer surface of the dental prosthesis, which forms the prosthetic teeth, is formed from the material of the milling body, and the remaining outer surface, which forms the prosthesis base, is formed from the material of the prosthesis base preform and the cured or partially polymerized plastics material. Provision may also be made to this end for this already to have been appropriately taken into account in the machining of the milling body in step B).

Provision may moreover be made for the introduction of the at least one fluid polymerizable plastic or adhesive in step E1) to proceed by packing and/or using an elevated pressure, in particular in a pressure pot or in a pressure chamber with a pressure above standard pressure, preferably using a pressure of at least 150 kPa, particularly preferably using a pressure of at least 200 kPa, and very particularly preferably using a pressure of at least 200 kPa and at most 400 kPa.

Provision may also be made for the introduction of at least one fluid polymerizable plastic or adhesive in step E1) to proceed by packing and/or using an elevated pressure, in particular in a pressure pot or in a pressure chamber, with a pressure of at most 1,000 kPa, preferably with a pressure of at most 500 kPa, particularly preferably with a pressure of at most 400 kPa.

Provision may further be made for the curing or partial curing of the fluid polymerizable plastic to proceed in step F) by the action of heat and/or pressure, wherein the curing or partial curing preferably proceeds over a period of between 10 minutes and 120 minutes, particularly preferably of between 30 minutes and 60 minutes.

Provision may also be made for the curing or partial curing of the at least one fluid polymerizable plastic or adhesive in step F) to proceed by photocuring, in particular by photopolymerization.

Provision may be made for the holding structure and the mating holding structure to be arranged such that they are arranged within the volume of the dental prosthesis which is to be produced. The holding structure and mating holding structure are consequently not visible on the surface of the dental prosthesis and cannot disrupt the structure there.

Provision may be made for the prosthesis base preform with the holding structure to be attached with defined spacing in step D) to the mating holding structure of the milling body.

Defined spacing means in this context that a defined and thus predetermined spacing is obtained or established between the prosthesis base preform and the machined surface of the milling body.

Provision may be made after step F) or after step G), for a step H) to proceed, in which the partially polymerized plastics material is finally cured, in particular is finally cured by photopolymerization, wherein preferably, subsequent to steps G) and H), polishing of the surface of the dental prosthesis and/or surface finishing of the dental prosthesis is preferably carried out.

In this way, an elevated final strength of the finally cured plastics material and thus of the dental prosthesis, in particular in the connection between the prosthetic teeth and the prosthesis base preform, is achieved.

Provision may further be made for the milling body to have a surrounding wall, wherein the surrounding wall of the milling body is retained in steps B) to F), wherein in step E1) the surrounding wall preferably comes into contact with the at least one fluid polymerizable plastic or adhesive, particularly preferably the at least one fluid polymerizable plastic or adhesive is introduced into the interspace such that the level rises up to the surrounding wall, but below a top of the surrounding wall.

This makes the method easier for a user to carry out. This reduces the risk of contaminating the surroundings with the fluid polymerizable plastic or adhesive.

Preferably, however, the method is carried out such that the cavity produced in the milling body in step B) for receiving the fluid polymerizable plastic or adhesive and for completely connecting the prosthesis base preform to the milling body is sufficient, without the fluid polymerizable plastic or adhesive escaping from the interspace over the unmachined surface of the milling body.

Provision may moreover be made for the prosthesis base preform to be fixed to the milling body in step D), preferably to be adhesively bonded to the milling body with the holding structure on the mating holding structure.

It can in this way be ensured that the prosthesis base preform does not float up on the fluid polymerizable plastic or adhesive or is not pushed away from the milling body on introduction of the fluid polymerizable plastic or adhesive into the interspace. As a result, a defined thickness of the cured or partially polymerized plastic between the prosthesis base preform and the prosthetic teeth fabricated from the milling body is achieved.

Provision may also be made for the prosthesis base preform to consist at least in part or completely of a gum-colored plastic.

This ensures that the prosthesis base can subsequently be fabricated straightforwardly and without elaborate post-machining from the prosthesis base preform and the cured or partially polymerized plastic. Moreover, the prosthesis base preform may consequently readily be fabricated from the gum-colored plastic using an additives CAM method.

Provision may preferably also be made for the prosthesis base preform to be produced before step A) by a CAM method, in particular by an additive CAM method, on the basis of the virtual three-dimensional model of a surface of a basal side of the prosthesis base of the dental prosthesis, wherein the basal side of the prosthesis base preform is preferably produced with an offset in the form of a basal material thickening.

In this way, the prosthesis base preform is still better adapted to the form of the prosthesis base of the dental prosthesis to be produced and also already largely customized to patient needs. This saves time during the concluding subtractive CAM method in step G) and also reduces the consumption of material. The offset in the form of the basal material thickening ensures that the higher precision of the final fabrication by the concluding subtractive CAM method in comparison with the less precise additive CAM method can be used to produce a high quality dental prosthesis.

Provision may here also be made for a material thickening to be provided in the production of the prosthesis base preform, wherein the material thickening has a thickness of at least 0.1 mm in comparison with the surface of the virtual three-dimensional model of the dental prosthesis in the region of the basal side of the prosthesis base, particularly preferably a material thickening of at least 0.1 mm and at most 2 mm, and very particularly preferably a material thickening of at least 0.3 mm and at most 1 mm.

This ensures that in step G) sufficient material is still present in the excess, in particular on the basal side of the prosthesis base preform, for no material to be lacking or having to be replenished after step G). This enables accurate fabrication of the dental prosthesis with the assistance of the subtractive CAM method, which operates more accurately.

Provision may here be made for no material thickening to be provided on the holding structure on production of the prosthesis base preform.

Since the interspace is filled with the fluid polymerizable plastic or adhesive, there is no need for any excess material of the prosthesis base preform at this point.

Provision may further be made for the prosthesis base preform to be preformed at least on a basal side to lie against gums, wherein the basal side is opposite the oral side, wherein the prosthesis base preform preferably is or has been preformed on the basal side with a U-shaped indentation for receiving a toothless mandibular arch and/or is or has been preformed to fit anatomically with the situation in a patient's oral cavity.

In this way, the consumption of material of the prosthesis base preform in step G) is reduced, and the time required for machining in step G) and thus the wear of tools of the subtractive CAM device (such as for example the milling heads) are also reduced.

Provision may moreover be made for the holding structure of the prosthesis base preform and the mating holding structure to be implemented in pairs by projecting posts and recesses which fit with the projecting posts, wherein in step D) the projecting posts are preferably inserted flush into the recesses fitting therewith.

In this manner, it is possible to make a simple and obvious and also stable connection of the prosthesis base preform to the machined milling body.

A further development of the inventive method also proposes that, in step D), the prosthesis base preform is pressed against the milling body until a limit stop is reached, wherein, apart from at the mating holding structure, the limit stop determines the spacing in the interspace between the prosthesis base preform and the machined surface of the milling body, wherein the holding structure of the prosthesis base preform and the mating holding structure of the milling body preferably form the limit stop.

The limit stop ensures that the desired spacing or the desired gap dimension between the prosthesis base preform and the machined surface of the milling body is automatically obtained on attachment in step D).

Provision may be made according to a further development for the holding structure of the prosthesis base preform and the mating holding structure to be arranged on the milling body within the dental prosthesis to be produced, preferably to be arranged within a connection between the prosthetic teeth and the prosthesis base.

This can ensure that the connection between the prosthesis base preform and the milling body cannot be located in a surface of the subsequent dental prosthesis and there cause a defect in the surface.

Provision may also be made for a defined spacing of the prosthesis base preform from the machined surface of the milling body to be produced in step D).

Defined spacing means in this context that a defined and thus predetermined spacing is obtained or established between the prosthesis base preform and the machined surface of the milling body. This ensures that both the orientation of the prosthesis base preform relative to the prosthetic teeth and the size and shape of the interspace are precisely established and consequently the subtractive CAM machining in step G) can proceed to a lesser extent, so in turn saving working time and resources in the form of plastic and milling head wear.

Provision may further be made for a spacing of the prosthesis base preform from the machined surface of the milling body of at least 0.02 mm and at most 2 mm, preferably of at least 0.02 mm and at most 1 mm, particularly preferably of at least 0.1 mm and at most 1 mm, and very particularly preferably of at least 0.3 mm and at most 1 mm to be produced in step D).

The spacing relates to all areas other than the connection of the holding structure to the mating holding structure.

This spacing ensures that the fluid polymerizable plastic or adhesive can readily be introduced or packed into the interspace.

In the event of step E2) being performed without step E1), it is preferred to select relatively small spacings of between 0.02 mm and 0.5 mm, preferably of between 0.02 mm and 0.3 mm, and particularly preferably of between 0.05 mm and 0.2 mm.

In the event of step E1) being performed with or without step E2), on the other hand, it is preferred to select large spacings of between 0.3 mm and 2 mm, preferably of between 0.3 mm and 1 mm, and particularly preferably of between 0.5 mm and 1 mm.

Provision may moreover be made for the at least one fluid polymerizable plastic or adhesive to be filled into the interspace in step E1) at least to such a filling level that the connecting surface of the prosthetic teeth and an oral surface of the prosthesis base preform, which is completely located within the virtual model of the prosthesis base, is completely wetted with the fluid polymerizable plastic.

This ensures that no entrapped air or gas is subsequently present in the dental prosthesis and the layers or parts of the dental prosthesis are stably and interlockingly connected.

Provision may also be made for the surface of the milling body, in which the connecting surface between the prosthetic teeth and the prosthesis base is produced in step B), to be a planar surface.

This facilitates subsequent introduction or application of the fluid polymerizable plastic or adhesive. In addition, a conventional commercial blank can be used as the milling body.

Provision may be made according to a preferred further development for the cured plastics material or the partially polymerized plastics material once completely cured to have material properties and/or a color which deviate from the gum-colored plastic of the prosthesis base preform, wherein the cured plastics material or the partially polymerized plastics material once completely cured preferably has a hardness and/or transparency which deviate from the gum-colored plastic of the prosthesis base preform.

In this way, the two-part structure of the prosthesis base from the prosthesis base preform and the cured (and optionally previously partially polymerized) plastics material which is obtained by curing from the fluid polymerizable plastic or adhesive may be utilized to produce a dental prosthesis which is particularly stable and/or of aesthetically realistic appearance.

Provision may also be made for the dental prosthesis to be carved in step G) by subtractive machining of the prosthesis base preform and the material of the milling body from the prosthesis base preform, the cured or partially polymerized plastics material and the material of the milling body or for the dental prosthesis to be carved in step G) by subtractive machining of the prosthesis base preform, the cured or partially polymerized plastics material and the material of the milling body from the prosthesis base preform, the cured or partially polymerized plastics material and the material of the milling body.

This machining enables the fabrication of a particularly accurate dental prosthesis on the basis of the virtual three-dimensional model of the dental prosthesis. In the first case, the cured or partially polymerized plastics material need not be machined. This is only successful if suitable preforming by the subtractive CAM method forms a shape in the milling body which is an exact negative shape of the prosthesis base in this region.

Provision may further be made for the prosthesis base preform to be attached spaced apart from the connecting surface of the milling body in step D), preferably with a spacing of at least 0.02 mm from the connecting surface of the milling body, particularly preferably with a spacing of at least 0.02 mm and at most 2 mm from the connecting surface of the milling body, and very particularly preferably with a spacing of at least 0.05 mm and at most 1 mm from the connecting surface of the milling body.

The spacing relates to all areas other than the connection of the holding structure to the mating holding structure.

This spacing ensures that the fluid polymerizable plastic or adhesive can readily be introduced or packed into the interspace between the connecting surface of the milling body and the prosthesis base preform or a sufficient gap dimension is present for application of the fluid polymerizable plastic or adhesive.

Provision may moreover be made for the introduction in step E1) of the at least one fluid polymerizable plastic or adhesive into the interspace between the milling body and the prosthesis base preform and into the volume in the surface of the milling body machined away in step B) to proceed such that the at least one fluid polymerizable plastic or adhesive connects the machined milling body to the prosthesis base preform, wherein preferably the at least one fluid polymerizable plastic or adhesive completely wets the surface of the milling body machined in step B) and an attachment face on the oral side of the prosthesis base preform, and/or the interspace is completely filled, in particular without entrapped gas, with the at least one fluid polymerizable plastic or adhesive, or in step E2) application of the at least one fluid polymerizable plastic or adhesive onto the oral surface of the prosthesis base preform and/or onto the connecting surface of the milling body produced in step B), and in step D) attachment of the prosthesis base preform to the machined milling body proceeds such that the at least one fluid polymerizable plastic or adhesive connects the machined milling body to the prosthesis base preform, wherein preferably the at least one fluid polymerizable plastic or adhesive completely wets the surface of the milling body machined in step B) and an attachment face on the oral side of the prosthesis base preform and/or the interspace is completely filled, in particular without entrapped gas, with the at least one fluid polymerizable plastic or adhesive.

This ensures that no entrapped air or gas is subsequently present in the dental prosthesis and the layers or parts of the dental prosthesis are stably and interlockingly connected.

Provision may be made according to a further development for an indentation in the surface of the milling body to be made in step B) adjacent to the connecting surface between the prosthetic teeth and the prosthesis base with the assistance of the subtractive CAM method, preferably in accordance with the virtual three-dimensional model of the surface of the dental prosthesis, wherein the indentation is preferably produced as an indentation completely surrounding the connecting surface, particularly preferably as an indentation of a width of at least 0.5 mm and at most 10 mm completely surrounding the connecting surface.

This indentation may be used in step E1) to be filled with the at least one fluid polymerizable plastic or adhesive, or in step E2) to accommodate the at least one fluid polymerizable plastic or adhesive on application. In this way, it is possible to achieve a large-area connection between the milling body and the at least one fluid polymerizable plastic or adhesive. In addition, introduction or application is facilitated in this way and the indentation can receive the at least one fluid polymerizable plastic or adhesive.

The indentation may preferably be a flow channel. The flow channel may particularly preferably be annular.

Provision may further be made for the at least one fluid polymerizable plastic or adhesive, on introduction in step E1) or on application in step E2), to completely wet the surfaces of the milling body machined in step B) and/or to wet the oral surface of the prosthesis base preform at least in places, wherein preferably the milling body has, on the surface intended for machining by the subtractive CAM method, and/or the prosthesis base preform has, on the surface which is not to be wetted with the fluid polymerizable plastic or adhesive, a coating which prevents wetting with the at least one fluid polymerizable plastic or adhesive.

This ensures that all the regions which are subsequently located within the dental prostheses are completely filled with the material of the milling body, the cured or partially polymerized plastics material and the material of the prosthesis base preform.

Provision may also be made for the oral side of the prosthesis base preform to be produced in accordance with the virtual three-dimensional model of the shape of the connecting surface of the prosthetic teeth to the prosthesis base in the dental prosthesis, in particular by a CAM method or an additive CAM method, wherein, on calculation of the surface of the oral side of the prosthesis base preform, volume is preferably removed from the virtual three-dimensional outer shape of the prosthesis base, particularly preferably with a thickness of between 0.3 mm and 2 mm, and very particularly preferably with a thickness of between 0.5 mm and 1 mm.

A defined gap dimension or a defined spacing between the prosthesis base and the prosthetic teeth may be achieved in this way. This results in a uniform and stable connection of the prosthesis base preform to the prosthetic teeth.

Provision may moreover be made for subtractive machining of the cured or partially polymerized plastics material, the prosthesis base preform and the milling body to proceed in step G) from the direction of an underside of the milling body, which is opposite a surface of the milling body machined in step B), by the CAM method in accordance with an occlusal surface and an oral surface of the virtual model of the dental prosthesis and/or for subtractive machining of the cured or partially polymerized plastics material, the prosthesis base preform and the milling body to proceed in step G) from a direction of the surface of the milling body machined in step B) by the CAM method in accordance with a basal surface of the virtual model of the dental prosthesis.

This ensures that the respective surfaces are fabricated from the desired materials of the milling body, the prosthesis base preform and the cured or partially polymerized plastics material.

Provision may be made for a step B2) to proceed after step B):

B2) cleaning and/or pretreating the surface of the milling body machined in step B) or the entire upper side of the milling body containing the machined surface, wherein pretreatment preferably involves a chemical treatment of the surface of the first material, particularly preferably chemical swelling of the surface of the first material with a monomer liquid, wherein the material of the milling body is a plastics composition containing a polymethyl methacrylate (PMMA) or consisting of a PMMA.

A particularly stable connection between the first material and the cured or partially polymerized plastics material is produced in this way.

A further development of the present invention proposes that the holding structure of the prosthesis base preform and the mating holding structure form three defined contact points, such that, on attachment of the prosthesis base preform with the holding structure to the mating holding structure of the milling body in step D), the prosthesis base preform is attached to the mating holding structure of the milling body via the three defined contact points of the holding structure.

This three-point attachment provides a connection between the prosthesis base preform and the milling body which is stable, positionally fixed and immobile.

Provision may further be made for photopolymerization to be carried out on curing or partial curing in step F), wherein final curing by photopolymerization preferably proceeds after step G).

A stable dental prosthesis with a stable connection between the prosthetic teeth and the prosthesis base preform can straightforwardly be produced in this way. On photopolymerization, the fluid polymerizable plastic or adhesive may be partially gelled on partial curing.

Provision may moreover be made for a cavity for receiving the fluid polymerizable plastic or adhesive to be arranged on the surface of the milling body intended for machining by the subtractive CAM method, wherein the cavity has a bottom and, starting from the edge of the bottom, is laterally bounded by a surrounding wall, wherein the surrounding wall is annular and wherein the material suitable for prosthetic teeth forms the bottom and extends to an underside of the milling body which is arranged opposite the upper side of the milling body.

Introduction of the at least one fluid polymerizable plastic or adhesive is facilitated in this way.

An annular wall for the purposes of the present invention has a recess which surrounds the geometric center point of the recess. The recess is preferably shaped without undercuts and/or each point in the recess is connectable in a straight line with each other point in the recess without the straight line extending within the surrounding wall. The recess is preferably a compact geometric body.

The objects underlying the present invention are also achieved by a dental prosthesis produced using an above-described method.

The dental prosthesis has the advantages achieved by the method. It can thus be fabricated particularly inexpensively, rapidly and with little waste.

Provision may here be made for the prosthesis base to have a two-part structure, in which a subtractively machined prosthesis base preform with a plastics material cured or partially polymerized from at least one fluid polymerizable plastic or adhesive is connected to the subtractively machined prosthetic teeth, wherein the surface of the cured or partially polymerized plastics material is preferably likewise subtractively machined.

The objects underlying the present invention are also solved by a device for implementing such a method, the device having a connecting surface calculation module for calculating a connecting surface between prosthetic teeth and prosthesis base in accordance with a virtual three-dimensional model of a shape of the connecting surface of the prosthetic teeth to the prosthesis base in the dental prosthesis; a prosthesis base preform calculation module for calculating a virtual model of the surface of a prosthesis base preform in accordance with a virtual three-dimensional model of a shape of the connecting surface of the prosthetic teeth to the prosthesis base and a basal side of the prosthesis base of the dental prosthesis; a connecting surface control module for a CAM device programmed to control the subtractive production of the connecting surface, calculated with the connecting surface calculation module, in a milling body; and a dental prosthesis control module for a CAM device programmed to control the subtractive production of the surface of the dental prosthesis to be produced in accordance with the virtual model of an outer surface of the dental prosthesis.

The device may be a controller for a CAD/CAM device with which dental prostheses are producible, wherein the inventive device is provided by suitable programming of the CAD/CAM device. A suitable CAD/CAM device known from the prior art for producing a dental prosthesis may thus be converted into an inventive device by a software update with suitable programming.

Provision may here be made for the device to have a mating holding structure calculation module which calculates and positions a mating holding structure in the surface of the milling body relative to the connecting surface and preferably within the connecting surface, wherein the mating holding structure forms a counterpart which fits with a holding structure of a prosthesis base preform, wherein the connecting surface control module for a CAM device is preferably programmed to control the subtractive production of the connecting surface to the mating holding structure in the milling body calculated with the connecting surface calculation module and the mating holding structure calculation module.

The invention is based on the surprising recognition that it is possible by using a prosthesis base preform, which is applied with positioning aids (in the form of holding structures and mating holding structures) to a milling body individually machined (in accordance with a virtual model of a connecting surface) for producing prosthetic teeth and is connected with at least one fluid polymerizable plastic or adhesive, to create a precursor (or intermediate) for producing a dental prosthesis from which a definitive individual dental prosthesis can be carved by way of a subtractive CAM method, without in so doing resulting in long machining times with severe wear of the tools and large volumes of waste of the materials to be machined. An interspace may here be used for introducing or applying a fluid polymerizable plastic or adhesive, wherein the quantity of fluid polymerizable plastic or adhesive consumed can be kept small. It is possible to fabricate large proportions both of the prosthetic teeth and of the prosthesis base or even both parts completely from materials which do not consist of a cured and previously fluid flowable plastic (such as a powder/liquid PMMA).

Thanks to the basic geometry already roughly corresponding to the final dimensions, material consumption can be significantly reduced. A broader range of materials can also be used, there no longer being any limitation to PMMA. Milling times can also be significantly reduced due to the reduced subtractive material removal. Because the final finish milling only proceeds in the adhesively bonded or connected state, the result corresponds very accurately to the digital database, i.e. the virtual three-dimensional model of the dental prosthesis to be produced.

The inventive method achieves a high accuracy of fit of the dental molding thanks to the direct milling of the final shaping. No effort has to be expended for adhesively bonding individual prosthetic teeth and no nonuniformities arising from a joining process occur in the dental molding. At the same time, by completely curing the milling body or using a particularly hard and solid milling body, it is possible to obtain a particularly abrasion-resistant material for prosthetic teeth and, by using a layered milling body, a particularly aesthetically attractive prosthetic tooth material. A natural gum-colored to tooth-colored color transition is obtained at the correct locations in dental prostheses and no compromises need be made. Particularly good aesthetics can here be achieved by using multilayer milling disks as tooth-colored solid bodies.

A particularly high-quality appearance of the resultant dental prosthesis can here be assisted by the at least one fluid polymerizable plastic or adhesive having a different color and/or transparency and/or another outward appearance to the material of the prosthesis base preform.

Production from the milling body, the cured fluid polymerizable plastic or adhesive, the prosthesis base preform and using the inventive method may proceed in just a two-stage or three-stage production process. A two-stage or three-stage method may thus be used for producing the dental moldings. Furthermore, no different variant shapes of blanks or molding bodies are necessary. However, a very small set of differently sized milling blanks may also be used or be advantageous.

An exemplary inventive method for producing a dental prosthesis (full or partial dental prosthesis as dental molding) may have the following sequence:
1. Digital design of the prosthetic work and separation into a plurality of data segments. Data are required for the occlusal or oral upper side, basal underside of the dental prosthesis and interfacial data consisting of the basal face of the tooth-colored portions and upper side (oral side) of the gum-colored portions as connecting surface. An additional offset to the gum-colored portions may optionally have to be provided when generating the data regarding the occlusal or oral upper side.
2. Development of a suitable milling strategy for processing the individual process steps. One-sided machining of the underside, and a zero shift appropriate to the milling body used, preferably together with a further zero shift for machining both sides with a corresponding zero shift for the upper side and underside are preferably planned separately from one another or carried out consecutively.
3. Attachment of a milling body at least corresponding to the size of the tooth-colored portions or a tooth-colored solid body of the milling body into the milling machine and milling of the interfacial data and the data regarding the occlusal or oral upper side of the prosthesis base from the basal direction, optionally with a slight offset to the gum-colored portions (the prosthesis base) in the oral direction. Prior to positioning, the milling body or the tooth-colored solid body may preferably be provided with a position marker which enables repositioning.
4. Production of the prosthesis base preform using an additive CAM method in accordance with the digital design optionally with an offset for enlarging the basal side of the prosthesis base preform and for reducing material on the oral side of the prosthesis base preform in comparison with the prosthesis base according to the virtual model of the dental prosthesis.
5. Removal of the partially milled milling body and placement of the prosthesis base preform onto the partially milled milling body with the assistance of positioning aids for correct orientation of the prosthesis base preform on the partially milled milling body in accordance with the digital design of the dental prosthesis, such that an interspace remains between the prosthesis base preform and the partially milled milling body.
6. Filling of the interspace or prior application onto the surfaces of the prosthesis base preform bounding the interspace and/or the partially milled milling body with a fluid polymerizable plastic or adhesive (preferably with a powder/liquid system) and polymerization in the analogous fabrication method. Any necessary post-treatment of the cured plastics material, such as for example by immersion in water, is then performed.
7. Repositioning of the filled partially milled composite in the milling machine and milling of the outer geometries basally and orally in accordance with the final prosthesis design.

The method may be concluded by surface finishing of the dental prosthesis by polishing and/or chemical treatment.

Exemplary embodiments of the invention are explained below with reference to ten schematic figures and one flow chart but without thereby limiting the invention. In the figures:

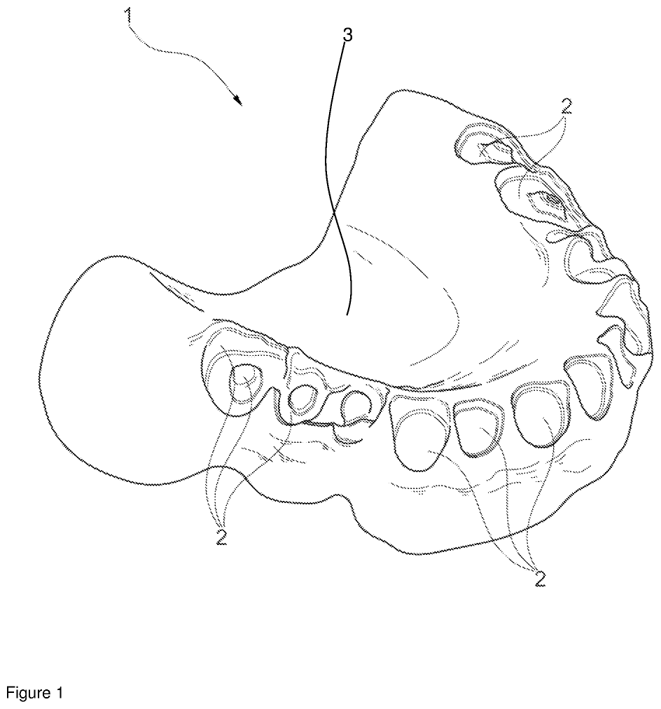

FIG. 1: is a schematic perspective view of a virtual three-dimensional model of a prosthesis base;

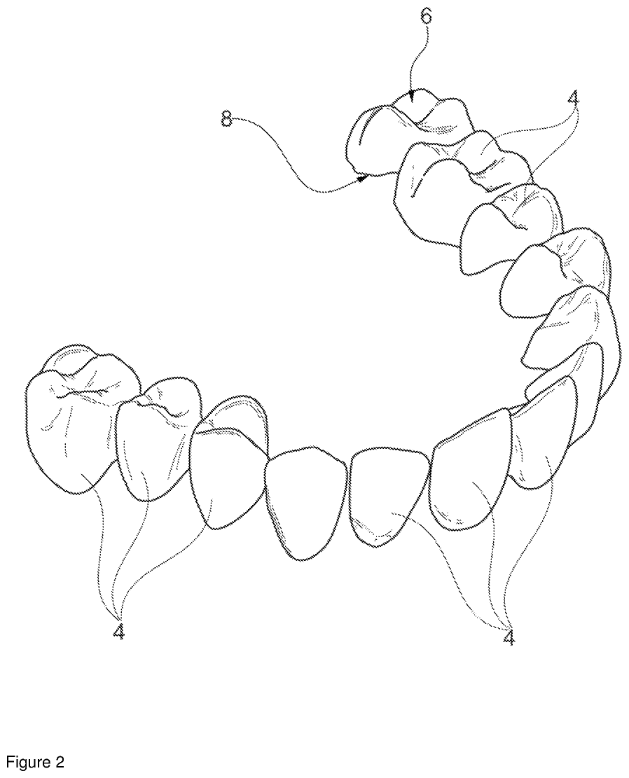

FIG. 2: is a schematic perspective view of a virtual three-dimensional model of prosthetic teeth which fit the prosthesis base according to FIG. 1;

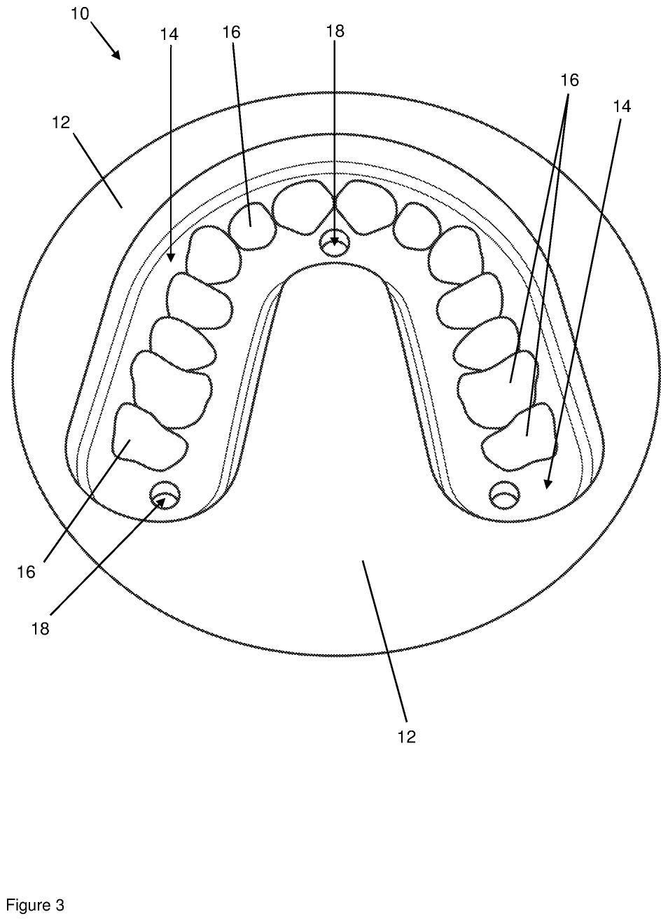

FIG. 3: is a schematic perspective view of a virtual three-dimensional model of a milling body machined on one side with carved connecting surface;

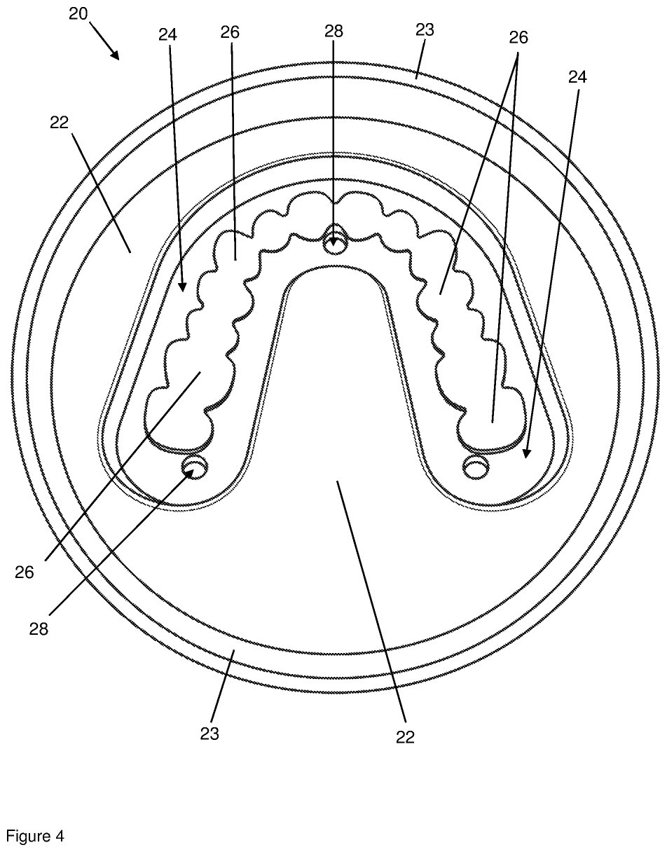

FIG. 4: is a schematic perspective view of a milling body machined on one side with carved connecting surface;

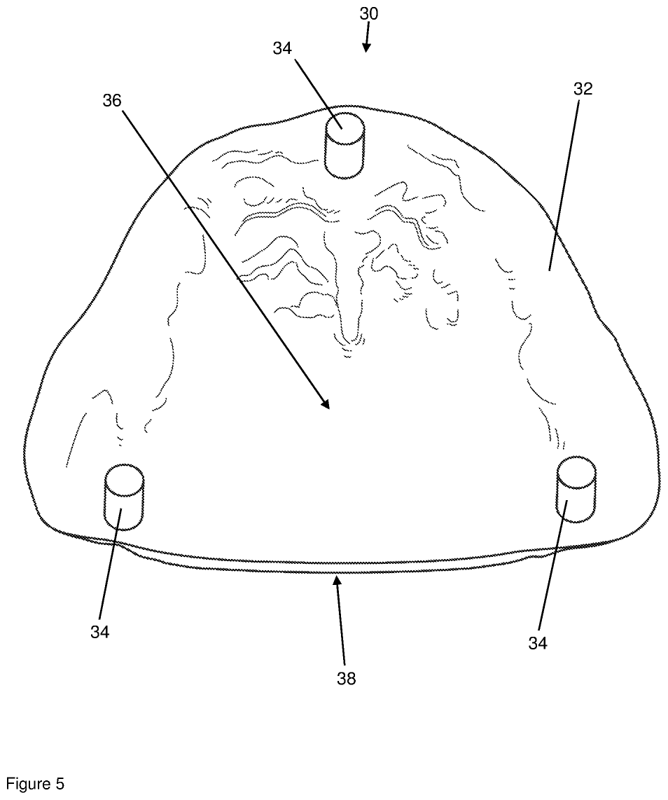

FIG. 5: is a schematic perspective view of a prosthesis base preform;

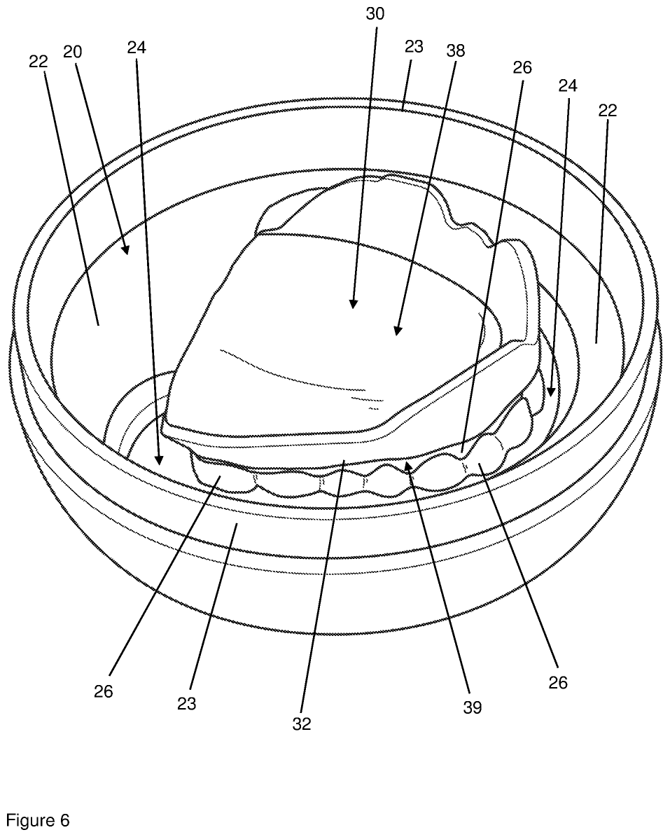

FIG. 6: is a schematic perspective view of the milling body machined on one side with carved connecting surface according to FIG. 4 with prosthesis base preform attached thereto;

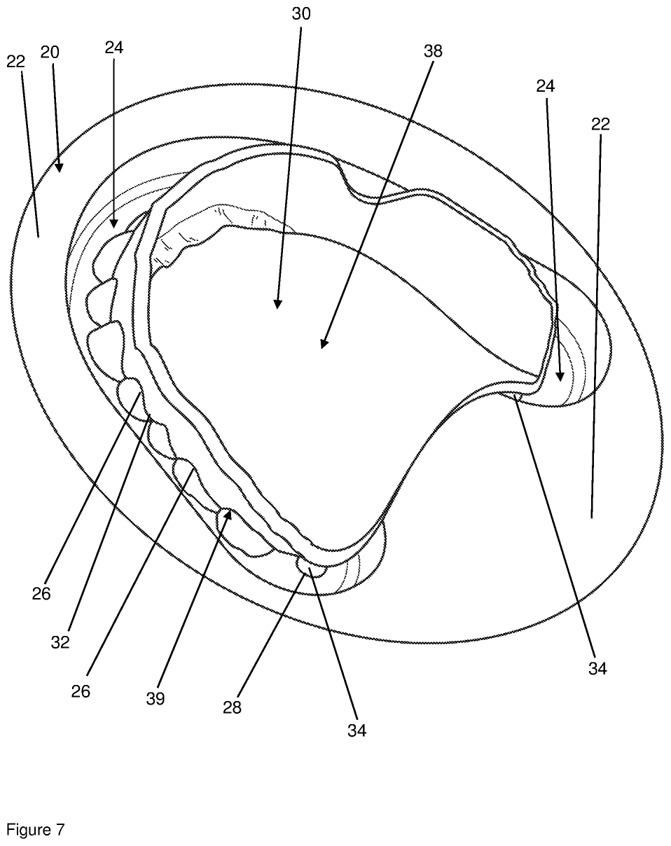

FIG. 7: is a schematic perspective view of a milling body machined on one side with carved connecting surface with prosthesis base preform attached thereto;

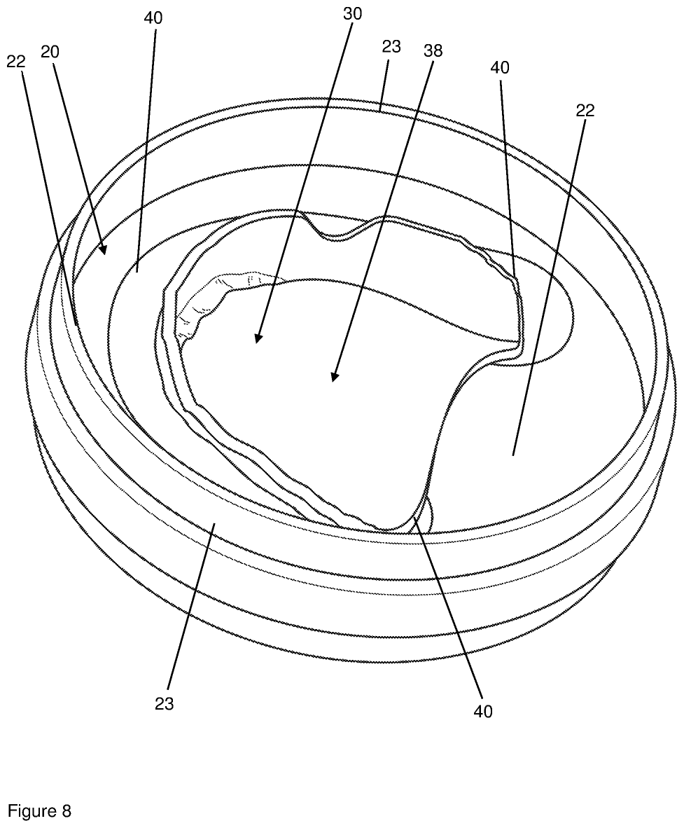

FIG. 8: is a schematic perspective view of the milling body machined on one side with carved connecting surface according to FIG. 4 with prosthesis base preform attached thereto and introduced fluid polymerizable plastic;

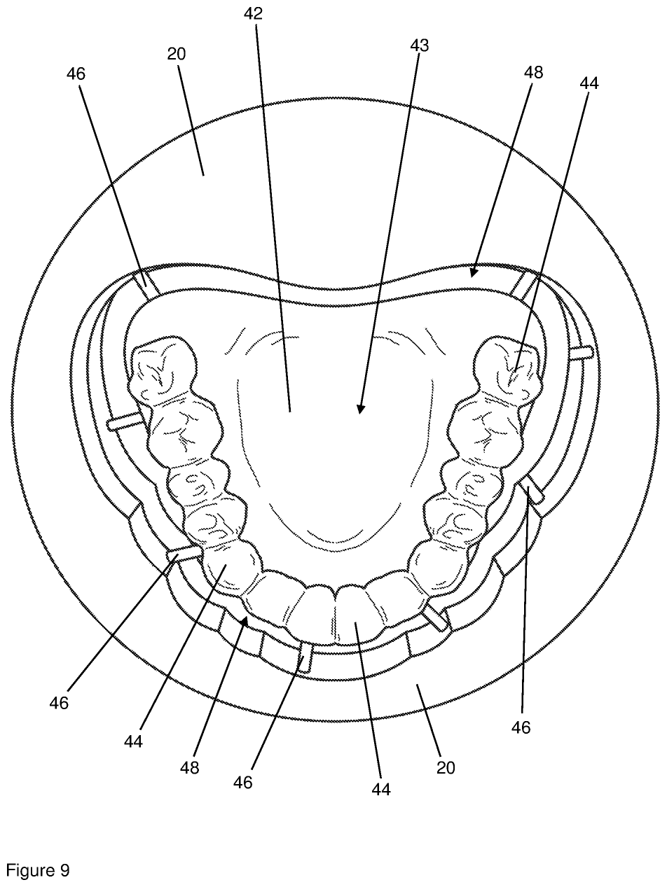

FIG. 9: is a schematic perspective plan view onto the oral side of the dental prosthesis carved from the milling body, cured plastic and the prosthesis base preform, the prosthesis still being connected to the remainder of the milling body via bridges;

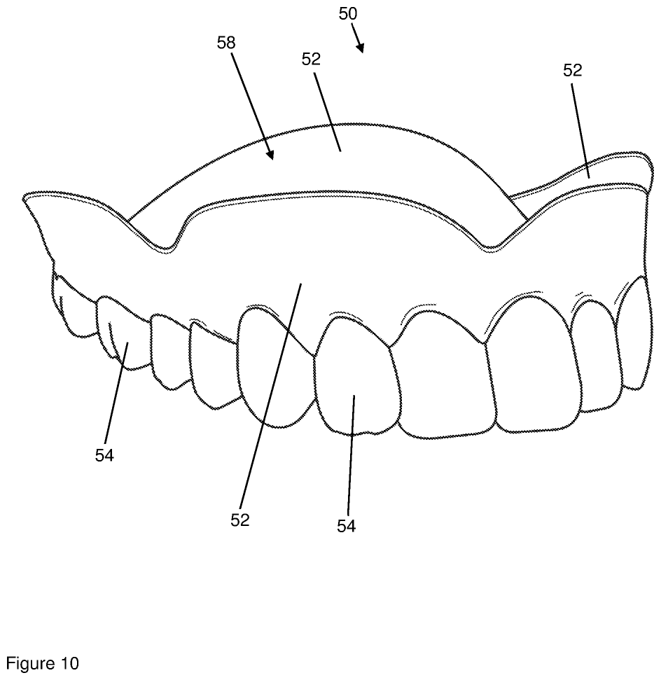

FIG. 10: is a schematic perspective view of the dental prosthesis produced by the inventive method; and

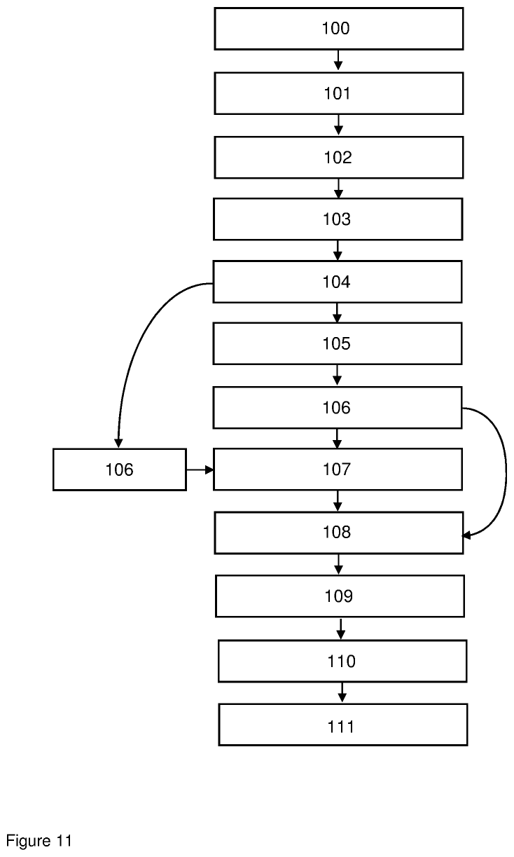

FIG. 11: shows the sequence of an inventive method for producing a dental prosthesis.

FIGS. 1 and 2 show a schematic perspective view of a virtual three-dimensional model of a prosthesis base 1 (FIG. 1) and of a virtual three-dimensional model of prosthetic teeth 4 (FIG. 2) which fit the prosthesis base 1 according to FIG. 1. The virtual three-dimensional models of the prosthesis base 1 and the prosthetic teeth 4 may have been obtained computationally by file splitting of a virtual three-dimensional model of the dental prosthesis to be produced (see FIG. 10). To this end, the outer shapes of the prosthetic teeth 4 and the prosthesis base 1 in the CAD model may be separated from one another, such that, once assembled again, they provide the complete dental prosthesis.

The contact area between the prosthesis base 1 and the prosthetic teeth 4 is formed by a connecting surface 2 which may have the shape of dental alveoli in the prosthesis base 1. On the basal sides 8 of the prosthetic teeth 4, which are arranged opposite the occlusal ends 6, there is a surface which fits flush with a connecting surface 2. The prosthesis base 1 may have a palate plate 3 if it is intended for the upper jaw. A prosthesis base for the lower jaw does not have a palate plate.

In the finished dental prosthesis, the prosthetic teeth 4 should consist of a tooth-colored (whitish or cream-colored) hard plastic or of a tooth-colored (whitish or cream-colored) hard ceramic, while the prosthesis base 1 in the finished dental prosthesis should consist of a gum-colored (pink-colored) plastic.

FIG. 3 shows a schematic perspective view of a virtual three-dimensional model of a milling body 10 machined on one side with carved connecting surface 16 and FIG. 4 shows a schematic perspective view of a milling body machined on one side with carved connecting surface 26, which has been produced by a subtractive CAM method in accordance with the virtual three-dimensional model of FIG. 3.

The virtual three-dimensional model of the milling body 10 machined on one side may be produced by a CAD method and contains the connecting surface 16, which corresponds to a virtual connecting surface 16 between prosthetic teeth 4 and a prosthesis base 1 in a virtual three-dimensional model of the dental prosthesis to be produced.

The virtual three-dimensional model of the milling body 10 machined on one side should be milled on a milling body surface 12. Virtual three-dimensional surfaces are accordingly arranged as structures in this milling body surface 12.

A flow channel 14, which is intended for receiving fluid polymerizable plastic 40 (see FIG. 8) or adhesive, may be provided around the connecting surface 16. The flow channel 14 may be annular in shape.

Furthermore, a virtual three-dimensional mating holding structure 18 in the form of three cylindrical holes may be arranged in the virtual three-dimensional model of the machined milling body 10. The mating holding structure 18 serves for attachment of a prosthesis base preform 30 (see FIG. 5).

On the basis of this virtual three-dimensional model of the machined milling body 10, the real milling body 20 is milled by a subtractive CAM method on a milling body surface 22 and the structures corresponding to the virtual three-dimensional model are carved out of or into the surface. The structures may accordingly include a flow channel 24, the connecting surface 26 and a mating holding structure 28.

The milling body 22 may have a surrounding, annular wall 23. This surrounding, annular wall 23 allows the milling body surface 22 to be filled with the fluid polymerizable plastic 40 or adhesive beyond the flow channel 24 or may also simply function as a safety mechanism which prevents the fluid polymerizable plastic 40 or adhesive from escaping and contaminating the surroundings during filling or adhesive bonding.

FIG. 5 shows a schematic perspective view of a prosthesis base preform 30. The prosthesis base preform 30 has an oral surface 32 for connecting the prosthetic teeth 54 or for connection with the connecting surface 26 of the machined milling body 20.

The prosthesis base preform 30 can be produced by a generative (additive) CAM method. A virtual three-dimensional model of the prosthesis base 1 may be used as the starting data set for this purpose. By way of an offset, volume can be removed from an oral side 36 of the virtual three-dimensional model of the prosthesis base 1 in order to provide an interspace 39 or gap between an oral surface 32 for connecting the prosthetic teeth 54 (or the connecting surface 26) and the connecting surface 26. Furthermore, volume can be supplemented on a basal side of the virtual three-dimensional model of the prosthesis base 1 in order to ensure that sufficient material of the prosthesis base preform 30 is present if the prosthesis base 42, 52 (see FIGS. 9 and 10) is subsequently to be subtractively carved out from this region.

The prosthesis base preform 30 has an oral side 36 and a basal side 38 for lying against the toothless jaw. Optionally with the exception of the offset, the basal side 38 may already be a good fit for the basal side of the virtual model of the dental prosthesis or prosthesis base 1 of the dental prosthesis.

Holding structures 34 may be or have been arranged on the oral side 36 of the prosthesis base preform 30. The holding structures 34 are preferably embodied to precisely match the location and shape of the mating holding structures 28. The holding structures 34 and the mating holding structures 28 may to this end already have been suitably designed in the milling body 20 in the virtual three-dimensional CAD model of the prosthesis base preform 30 and/or the machined surface 24, 26, 28. The holding structures 34 may for example take the form of three cylindrical pegs projecting at different locations. This then permits placement against the machined milling body 20 at three points. This ensures exact positioning of the prosthesis base preform 30 against the machined milling body 20.

For attachment of the prosthesis base preform 30 (see FIG. 5) to the machined milling body 20 (see FIG. 4), the prosthesis base preform 30 and the machined milling body 20 can be connected together via the holding structures 34 and the mating holding structures 28. This is shown in FIG. 6 and FIG. 7 which are schematic perspective views of the milling body 20 machined on one side with carved connecting surface 26 and with the prosthesis base preform 30 attached thereto.

The prosthesis base preform 30 may also be a prefabricated component which is suitable for and appropriately selected to fit a group of patients. The three-dimensional shape of the oral side 36 or only the oral surface 32 is then preferably saved together with the holding structures 34 as a data set and can be taken into account in the design of the virtual three-dimensional model of the surface 24, 26, 28 to be machined in the milling body or the basal connecting surface 26, such that a defined interspace 39 with a defined gap dimension is obtained in the assembled state.

In any event, the prosthesis base preform 30 is or has been and the machined surface of the milling body 20 is produced such that a defined interspace 39 with a defined gap dimension is obtained in the assembled state. The interspace 39 may here be adapted to the nature of the desired fastening of the prosthesis base preform 30 to the milling body 20 or to the prosthetic teeth 54 (see FIG. 10). If, for example, the connection is to be made using only a fluid polymerizable adhesive which can be applied prior to assembly to the connecting surface 26 and/or the oral surface 32 for adhesive bonding, a narrow adhesive gap of between 0.02 mm and 0.3 mm may provide sufficient spacing. If a fluid polymerizable plastic is to be introduced, injected or packed into the interspace 39 once the prosthesis base preform 30 has been connected to the machined milling body 20, a larger gap of between 0.1 mm and 2 mm is a more sensible spacing.

FIG. 8 shows to this end a schematic perspective view of the milling body machined on one side with carved connecting surface according to FIG. 4 with the prosthesis base preform attached thereto and fluid polymerizable plastic 40 introduced into the interspace 39. The fluid polymerizable plastic 40 may be applied or injected either before or after attachment of the prosthesis base preform 30 to the machined milling body 20. The prosthesis plastic (1 or 2 components) can be prepared for this purpose and injected into the interspace 39. If required, specific regions may already be prefilled before the prosthesis base preform 30 is set in place. Before fluid polymerizable plastic 40 or adhesive escapes, the structure can be rotated and any excess runs into flow channel 24. As an alternative to injection, fluid polymerizable plastic 40 or adhesive can also simply be applied, after which the prosthesis base preform 30 is set in place.

Provision may also be made to produce a filling hole (not shown) in the milling body 20. This may for example proceed during subtractive machining of the milling body surface 22 for producing the connecting surface 28. The fluid polymerizable plastic 40 or adhesive can be introduced into the interspace 39 through the filling hole. In the case of a dental prosthesis 50 for the upper jaw with a palate plate, the filling hole may be located centrally while in the case of a dental prosthesis for the lower jaw a plurality of filling holes can be arranged in an arc in the alveolar ridge region.

The fluid polymerizable plastic 40 is then cured or partially cured in the interspace 39, such that the fluid polymerizable plastic 40 firmly connects the prosthesis base preform 30 to the machined milling body 20. The resultant intermediate product can then be further machined. The prosthesis base preform 30 may to this end be fixed to the milling body 20. A flask clamp may be used for this purpose.

In a subsequent step, the actual dental prosthesis 50 is carved by a subtractive CAM method in accordance with the virtual three-dimensional model of the dental prosthesis 50 from the intermediate product shown in FIG. 8. To this end, the prosthesis base 42 initially still remains connected via bridges 46 to the remainder of the milling body 20. This situation is shown in FIG. 9, wherein the direction of view is here onto the oral side 43 of the dental prosthesis. FIG. 9 shows a schematic perspective plan view onto the occlusal side of the dental prosthesis which has been carved from the milling body 20, the cured plastic 40 and the prosthesis base preform 30 and is still connected via the bridges 46 with the remainder of the milling body 20. The milling body 20 will now also be subtractively machined by the CAM method from the (oral or occlusal) side opposite to the previously machined milling body face 22 in order to carve the prosthetic teeth 44 from the material of the milling body 20. A recess 48 remains between the dental prosthesis 50 and the remainder of the milling body 20. The tooth segments produced from the milling body 20 remain in place.

In a following step, the bridges 46 are removed and the finished dental prosthesis 50 thus obtained. FIG. 10 shows to this end a schematic perspective view of the dental prosthesis 50 produced using the inventive method. The dental prosthesis 50 has a prosthesis base 52, which consists of the material of the prosthesis base preform 30 and of the cured polymerizable plastic 40, and a plurality of prosthetic teeth 54, wherein the prosthetic teeth 54 consist of the material of the milling body 20. A basal side 58 of the dental prosthesis 50 is intended to lie against the patient's toothless gums and optionally palate.

An exemplary method is explained below on the basis of the intermediate and finished products shown in FIGS. 1 to 10. The sequence of the exemplary method is shown schematically in FIG. 11.

In a first processing step 100, a virtual three-dimensional model of the dental prosthesis 50 to be produced is calculated by CAD.

In a following second processing step 101, the connecting surface 16 between prosthetic teeth 4 and prosthesis base 1 of the dental prosthesis is calculated in the virtual three-dimensional model. This may, for example, proceed by file splitting of the virtual three-dimensional model of the dental prosthesis into a tooth portion and a prosthesis base portion.

In a third processing step 102, the surface 24, 26, 28 which is to be produced in the milling body 20 and comprises the connecting surface 16, 26, the mating holding structure 28 and optionally the flow channel 24 is then calculated by a CAD method.

On this basis, in a fourth processing step 103 the surface 24, 26, 28 to be produced in the milling body surface 22 is produced in the milling body 20 by a subtractive CAM method. The connecting surface 26 is also produced by the CAM method.

In a fifth processing step 104, the prosthesis base preform 30 is produced or provided. The prosthesis base preform 30 may thus already exist or it may be produced for example using an additive/generative CAM method in accordance with the virtual three-dimensional model of the prosthesis base 1 (optionally with offset), as described above. To this end, the prosthesis base preform 30 may for example be printed from a plastic.

In a sixth processing step 105, fluid polymerizable plastic 40 or adhesive can be applied onto the prosthesis base preform 30 and/or the connecting surface 26 in the milling body 20.

Alternatively, the seventh processing step 106, in which the prosthesis base preform 30 is attached to the machined milling body 20, may proceed directly.

In a following eighth processing step 107, fluid polymerizable plastic 40 or adhesive is introduced into the interspace 39 between the prosthesis base preform 30 and the machined milling body 20. Either the sixth processing step 105 or the eighth processing step 107 must be performed, as is apparent from the flow chart according to FIG. 11.

In a ninth processing step 108, the fluid polymerizable plastic 40 or adhesive is cured or partially cured and the machined milling body 20 is thus firmly connected to the prosthesis base preform 30.

In a tenth processing step 109, the dental prosthesis 50 is subtractively carved from the composite produced in the ninth processing step 108.

Post-curing or final curing of the dental prosthesis 50 may then optionally proceed in an eleventh processing step 110.

In an optional twelfth processing step 111, the dental prosthesis 50 can undergo final machining, for example by surface finishing and/or polishing of the dental prosthesis 50.

The features of the invention disclosed in the above description, as well as in the claims, figures and exemplary embodiments, may be essential both individually and in any desired combination to realizing the invention in its various embodiments.

### LIST OF REFERENCE NUMERALS

1 Prosthesis base (virtual model)
2 Connecting surface (virtual model)
3 Palate plate (virtual model)
4 Prosthetic teeth (virtual model)
6 Occlusal surface of the prosthetic teeth (virtual model)
8 Basal side of the prosthetic teeth (virtual model)
10 Milling body machined on one side (virtual model)
12 Milling body surface (virtual model)
14 Flow channel (virtual model)
16 Connecting surface (virtual model)
18 Mating holding structure (virtual model)
20 Milling body machined on one side
22 Surface of the milling body
23 Annular wall
24 Flow channel
26 Connecting surface
28 Mating holding structure
30 Prosthesis base preform
32 Oral surface for connecting the prosthetic teeth
34 Holding structure
36 Oral side
38 Basal side
39 Interspace
40 Fluid polymerizable plastic
42 Prosthesis base
43 Oral side of the prosthesis base
44 Prosthetic teeth
46 Bridge
48 Recess
50 Dental prosthesis
52 Prosthesis base
54 Prosthetic teeth
58 Basal side
100 Processing step: calculation of a virtual 3D-model of a dental prosthesis
101 Processing step: calculation of a connecting surface between prosthetic teeth and prosthesis base of the dental prosthesis
102 Processing step: calculation of the surface to be produced in a milling body comprising the connecting surface by a CAD method
103 Processing step: production of the surface to be produced in the milling body with the connecting surface by a CAM method
104 Processing step: production or provision of the prosthesis base preform
105 Processing step: application of fluid polymerizable plastic or adhesive onto the prosthesis base preform and/or the connecting surface in the milling body
106 Processing step: attachment of the prosthesis base preform to the machined milling body
107 Processing step: introduction of fluid polymerizable plastic or adhesive into an interspace between the prosthesis base preform and the milling body
108 Processing step: curing of the fluid polymerizable plastic or adhesive
109 Processing step: subtractive carving of the dental prosthesis
110 Optional processing step: post-curing or final curing of the dental prosthesis
111 Optional processing step: final machining of the dental prosthesis

1. A method for producing a dental prosthesis,
wherein the dental prosthesis has a plurality of prosthetic teeth and a prosthesis base, wherein the prosthesis base includes a gum-colored plastic and wherein the prosthetic teeth and the prosthesis base) are firmly connected together in the method, wherein the method comprises the following steps:
A) providing a milling body for producing the prosthetic teeth from a material suitable for prosthetic teeth and providing a prosthesis base preform, wherein the prosthesis base preform has a holding structure on an oral side of the prosthesis base preform;
B) producing a connecting surface between the prosthetic teeth and the prosthesis base in a surface of the milling body with the assistance of a subtractive CAM method in accordance with a virtual three-dimensional model of the connecting surface of the prosthetic teeth to the prosthesis base in the dental prosthesis;
C) producing a mating holding structure in the surface of the milling body, wherein the mating holding structure forms a counterpart which fits with the holding structure of the prosthesis base preform, or the milling body has the mating holding structure which fits with the holding structure of the prosthesis base preform;
D) after steps A), B), and C), attaching the prosthesis base preform with the holding structure to the mating holding structure of the milling body, wherein, apart from at the mating holding structure, the prosthesis base preform is attached spaced apart from the machined surface of the milling body such that an interspace open to the outside is obtained between the prosthesis base preform and the milling body;
E1) after step D), introducing at least one fluid polymerizable plastic or adhesive into the interspace between the milling body and the prosthesis base preform and into the volume in the surface of the milling body machined away in step B); and/or
E2) before step D), applying at least one fluid polymerizable plastic or adhesive onto an oral surface of the prosthesis base preform and/or onto the connecting surface produced in step B) of the milling body;
F) after step E1) or after step E2) or after step D), curing or partially curing the at least one fluid polymerizable plastic or adhesive, wherein, on curing, a cured plastic material is obtained in the interspace or, on partial curing, a partially polymerized plastic material is obtained in the interspace, wherein the cured plastic material or the partially polymerized plastic material connects the prosthesis base preform firmly and flush to the material of the milling body; and
G) after step F), subtractively machining the cured or partially polymerized plastic material, the prosthesis base preform, and the milling body by a CAM method in accordance with a virtual model of an outer surface of the dental prosthesis, such that the dental prosthesis is subtractively carved out from the prosthesis base preform, the cured or partially polymerized plastic material, and the material of the milling body.

2. The method according to claim 1, wherein after step F) or after step G), a step H) proceeds in which the partially polymerized plastic material is finally cured, in particular is finally cured by photopolymerization, wherein preferably, subsequent to step G) and H), polishing of the surface of the dental prosthesis and/or surface finishing of the dental prosthesis is carried out.

3. The method according to claim 1, wherein the milling body has a surrounding wall, wherein the surrounding wall of the milling body is retained in steps B) to F), wherein in step E1) the surrounding wall preferably comes into contact with the at least one fluid polymerizable plastic or adhesive, particularly preferably the at least one fluid polymerizable plastic or adhesive is introduced into the interspace such that the level rises up to the surrounding wall, but below a top of the surrounding wall.

4. The method according to claim 1, wherein the prosthesis base preform is fixed to the milling body in step D), preferably by being adhesively bonded to the milling body with the holding structure on the mating holding structure.

5. The method according to claim 1, wherein the prosthesis base preform comprises or consists of a gum-colored plastic.

6. The method according to claim 1, wherein the prosthesis base preform is produced before step A) by a CAM method, in particular by an additive CAM method, on the basis of the virtual three-dimensional model of a surface of a basal side of the prosthesis base of the dental prosthesis, wherein the basal side of the prosthesis base preform is preferably produced with an offset in the form of a basal material thickening.

7. The method according to claim 6, wherein a material thickening is provided in the production of the prosthesis base preform, wherein the material thickening has a thickness of at least 0.1 mm in comparison with the surface of the virtual three-dimensional model of the dental prosthesis in the region of the basal side of the prosthesis base, particularly preferably a material thickening of at least 0.1 mm and at most 2 mm, and very particularly preferably a material thickening of at least 0.3 mm and at most 1 mm.

8. The method according to claim 1, wherein the prosthesis base preform is preformed at least on a basal side to lie against gums, wherein the basal side is opposite the oral side, wherein the prosthesis base preform preferably is or has been preformed on the basal side with a U-shaped indentation for receiving a toothless mandibular arch and/or is or has been preformed to fit anatomically with the situation in a patient's oral cavity.

9. The method according to claim 1, wherein the holding structure of the prosthesis base preform and the mating holding structure are implemented in pairs by projecting posts and recesses which fit with the projecting posts, wherein in step D) the projecting posts are preferably inserted flush into the recesses fitting therewith.

10. The method according to claim 1, wherein in step D), the prosthesis base preform is pressed against the milling body until a limit stop is reached, wherein, apart from at the mating holding structure, the limit stop determines the spacing in the interspace between the prosthesis base preform and the machined surface of the milling body, wherein the holding structure of the prosthesis base preform and the mating holding structure of the milling body preferably form the limit stop.

11. The method according to claim 1, wherein the holding structure of the prosthesis base preform and the mating holding structure are arranged on the milling body within dental prosthesis to be produced, preferably are arranged within a connection between the prosthetic teeth and the prosthesis base.

12. The method according to claim 1, wherein a defined spacing of the prosthesis base preform from the machined surface of the milling body is produced in step D).

13. The method according to claim 1, wherein a spacing of the prosthesis base preform from the machined surface of the milling body of at least 0.02 mm and at most 2 mm, preferably of at least 0.02 mm and at most 1 mm, particularly preferably of at least 0.1 mm and at most 1 mm, and very particularly preferably of at least 0.3 mm and at most 1 mm is produced in step D).

14. The method according to claim 1, wherein the at least one fluid polymerizable plastic or adhesive is filled in step E1) at least to such a filling level in the interspace that the connecting surface of the prosthetic teeth and an oral surface of the prosthesis base preform, which is completely located within the virtual model of the prosthesis base, is completely wetted with the fluid polymerizable plastic.

15. The method according to claim 1, wherein the surface of the milling body, in which the connecting surface between the prosthetic teeth and the prosthesis base is produced in step B), is a planar surface.

16. The method according to claim 1, wherein the cured plastic material or the partially polymerized plastic material once completely cured has material properties and/or a color which deviate from the gum-colored plastic of the prosthesis base preform, wherein the cured plastic material or the partially polymerized plastic material once completely cured preferably has a hardness and/or transparency which deviate from the gum-colored plastic of the prosthesis base preform.

17. The method according to claim 1, wherein
the dental prosthesis is carved in step G) by subtractive machining of the prosthesis base preform and the material of the milling body from the prosthesis base preform, the cured or partially polymerized plastic material and the material of the milling body or
the dental prosthesis is carved in step G) by subtractive machining of the prosthesis base preform, the cured or partially polymerized plastic material and the material of the milling body from the prosthesis base preform, the cured or partially polymerized plastic material, and the material of the milling body.

18. The method according to claim 1, wherein the prosthesis base preform is attached spaced apart from the connecting surface of the milling body in step D), preferably with a spacing of at least 0.02 mm from the connecting surface of the milling body, particularly preferably with a spacing of at least 0.02 mm and at most 2 mm from the connecting surface of the milling body, and very particularly preferably with a spacing of at least 0.05 mm and at most 1 mm from the connecting surface of the milling body.

19. The method according to claim 1, wherein
the introduction in step E1) of the at least one fluid polymerizable plastic or adhesive into the interspace between the milling body and the prosthesis base preform and into the volume in the surface of the milling body machined away in step B) proceeds such that the at least one fluid polymerizable plastic or adhesive connects the machined milling body to the prosthesis base preform, wherein preferably the at least one fluid polymerizable plastic or adhesive completely wets the surface of the milling body machined in step B) and an attachment face on the oral side of the prosthesis base preform and/or the interspace is completely filled, in particular without entrapped gas, with the at least one fluid polymerizable plastic or adhesive, or
in step E2) application of the at least one fluid polymerizable plastic or adhesive onto the oral surface of the prosthesis base preform and/or onto the connecting surface of the milling body produced in step B), and in step D) attachment of the prosthesis base preform to the machined milling body proceeds such that the at least one fluid polymerizable plastic or adhesive connects the machined milling body to the prosthesis base preform, wherein preferably the at least one fluid polymerizable plastic or adhesive completely wets the surface of the milling body machined in step B) and an attachment face on the oral side of the prosthesis base preform and/or the interspace is completely filled, in particular without entrapped gas, with the at least one fluid polymerizable plastic or adhesive.

20. The method according to claim 1, wherein an indentation in the surface of the milling body is made in step B) adjacent to the connecting surface between the prosthetic teeth and the prosthesis base with the assistance of the subtractive CAM method, preferably in accordance with the virtual three-dimensional model of the surface of the dental prosthesis, wherein the indentation is preferably produced as an indentation completely surrounding the connecting surface, particularly preferably as an indentation of a width of at least 0.5 mm and at most 10 mm completely surrounding the connecting surface.

21. The method according to claim 1, wherein the at least one fluid polymerizable plastic or adhesive, on introduction in step E1) or on application in step E2), completely wets the surfaces of the milling body machined in step B) and/or wets the oral surface of the prosthesis base preform at least in places, wherein preferably the milling body has, on the surface intended for machining by the subtractive CAM method, and/or the prosthesis base preform has, on the surface which is not to be wetted with the fluid polymerizable plastic or adhesive, a coating which prevents wetting with the at least one fluid polymerizable plastic or adhesive.

22. The method according to claim 1, wherein the oral side of the prosthesis base preform is produced in accordance with the virtual three-dimensional model of the shape of the connecting surface of the prosthetic teeth to the prosthesis base in the dental prosthesis, in particular by a CAM method or an additive CAM method, wherein, on calculation of the surface of the oral side of the prosthesis base preform, volume is preferably removed from the virtual three-dimensional outer shape of the prosthesis base, particularly preferably with a thickness of between 0.3 mm and 2 mm, and very particularly preferably with a thickness of between 0.5 mm and 1 mm.

23. The method according to claim 1, wherein
subtractive machining of the cured or partially polymerized plastic material, the prosthesis base preform, and the milling body proceeds in step G) from a direction of an underside of the milling body, which is opposite the surface of the milling body machined in step B), by the CAM method in accordance with an occlusal surface and an oral surface of the virtual model of the dental prosthesis and/or
subtractive machining of the cured or partially polymerized plastic material, the prosthesis base preform and the milling body proceeds in step G) from a direction of the surface of the milling body machined in step B) by the CAM method in accordance with a basal surface of the virtual model of the dental prosthesis.

24. The method according to claim 1, wherein the holding structure of the prosthesis base preform and the mating holding structure form three defined contact points, such that, on attachment of the prosthesis base preform with the holding structure to the mating holding structure of the milling body in step D), the prosthesis base preform is attached to the mating holding structure of the milling body via the three defined contact points of the holding structure.

25. The method according to claim 1, wherein photopolymerization is carried out on curing or partial curing in step F), wherein final curing by photopolymerization preferably proceeds after step G).

26. The method according to claim 1, wherein a cavity for receiving the fluid polymerizable plastic or adhesive is arranged on the surface of the milling body intended for machining by the subtractive CAM method, wherein the cavity has a bottom and, starting from the edge of the bottom, is laterally bounded by a surrounding wall, wherein the surrounding wall is annular and wherein the material suitable for prosthetic teeth forms the bottom and extends to an underside of the milling body which is arranged opposite the upper side of the milling body.

27. A dental prosthesis produced with a method according to claim 1.

28. The dental prosthesis (50) according to claim 27, wherein the prosthesis base has a two-part structure, in which a subtractively machined prosthesis base preform with a plastic material cured or partially polymerized from at least one fluid polymerizable plastic or adhesive is connected to the subtractively machined prosthetic teeth, wherein the surface of the cured or partially polymerized plastics material is preferably likewise subtractively machined.

29. A device for implementing the method according to claim 1, the device comprising
a connecting surface calculation module for calculating a connecting surface between prosthetic teeth and prosthesis base in accordance with a virtual three-dimensional model of a shape of the connecting surface of the prosthetic teeth to the prosthesis base in the dental prosthesis;
a prosthesis base preform calculation module for calculating a virtual model of the surface of a prosthesis base preform in accordance with a virtual three-dimensional model of a shape of the connecting surface of the prosthetic teeth to the prosthesis base and a basal side of the prosthesis base of the dental prosthesis;
a connecting surface control module for a CAM device programmed to control the subtractive production of the connecting surface, calculated with the connecting surface calculation module, in a milling body; and
a dental prosthesis control module for a CAM device programmed to control the subtractive production of the surface of the dental prosthesis to be produced in accordance with the virtual model of an outer surface of the dental prosthesis.

30. The device according to claim 29, wherein
the device has a mating holding structure calculation module which calculates and positions a mating holding structure in the surface of the milling body relative to the connecting surface and preferably within the connecting surface, wherein the mating holding structure forms a counterpart which fits with a holding structure of a prosthesis base preform, wherein the connecting surface control module for a CAM device is preferably programmed to control the subtractive production of the connecting surface to the mating holding structure in the milling body calculated with the connecting surface calculation module and the mating holding structure calculation module.
